(19) United States
(12) Patent Application Publication
(10) Pub. No.: US 2026/0125031 A1
(43) Pub. Date: May 7, 2026

(54) VEHICLE SENSOR CLEANING DEVICE

(71) Applicants: Hyundai Motor Company, Seoul (KR); Kia Corporation, Seoul (KR); DY AUTO Corporation, Asan-si (KR)

(72) Inventors: Jong Min PARK, Hwaseong-si (KR); Sin Won KANG, Asan-si (KR); Jeong Goo LEE, Asan-si (KR)

(21) Appl. No.: 19/175,651

(22) Filed: Apr. 10, 2025

(30) Foreign Application Priority Data
Nov. 5, 2024 (KR) 10-2024-0154920

(51) Int. Cl. B60S 1/56; B60S 1/52

(52) U.S. Cl. CPC B60S 1/566; B60S 1/52

(57) ABSTRACT

A vehicle sensor cleaning device is configured to clean a cover glass of a sensor section of a vehicle. The vehicle sensor cleaning device includes a driving part configured to rotate and a movement part coupled to the driving part. The movement part is configured to clean the cover glass while moving along the cover glass based on rotation of the driving part, where the movement part is configured to contact the cover glass and perform a reciprocating motion for cleaning a surface of the cover glass.

### CROSS-REFERENCE TO RELATED APPLICATION

This application claims, under 35 U.S.C. § 119(a), the benefit of priority from Korean Patent Application No. 10-2024-0154920, filed on Nov. 5, 2024, the entire contents of which are incorporated herein by reference.

### TECHNICAL FIELD

The present disclosure relates to a vehicle cleaning device, and more particularly, to a cleaning device configured to clean a cover glass covering a sensor section of a vehicle and to clean and remove foreign substances (e.g., contaminants causing deterioration in sensor performance) attached to the exposed outer surface of the cover glass.

### BACKGROUND

An autonomous vehicle may be configured to recognize the external environment of the vehicle and the driver's condition without driver involvement in operating the vehicle, to use a recognition/determination algorithm so as to recognize and determine the surrounding environment, and to control the vehicle based on information obtained through the recognition/determination algorithm without driver involvement so as to reach a destination of the vehicle.

For example, an autonomous vehicle may utilize a plurality of sensors and a global positioning system (GPS) so as to recognize objects around the vehicle in the forward-and-rearward direction and the leftward-and-rightward direction of the vehicle. Examples of the sensors used in the autonomous vehicle include a camera, a radio detection and ranging (radar) sensor, and a light detection and ranging (LiDAR) sensor. Since each of these sensors has different characteristics, advantages, and disadvantages, autonomous driving may be performed by integrating various sensor systems with each other in the autonomous vehicle.

In some examples, an autonomous vehicle may include various sensors such as a camera, a LiDAR sensor, and a radar sensor integrally installed therein. For example, the camera sensor may be installed on the roof of the vehicle so as to recognize the front state of the autonomous vehicle. In some cases, external lens of the sensor installed on the outside of the vehicle may be contaminated by foreign substances such as dust, dirt, and asphalt and may be further contaminated by insect carcasses, bird droppings, rain, and snowfall caused by natural phenomena. When the lens is contaminated, the sensor may recognize incorrect information or may malfunction. When the sensor is not normally operated or is not capable of accurately recognizing the external situation, serious vehicle accidents may occur due to malfunction of the sensor.

### SUMMARY

The present disclosure describes a device capable of intuitively and effectively cleaning a cover glass covering a sensor of a vehicle.

According to one aspect of the subject matter described in this application, a vehicle sensor cleaning device for a vehicle having a sensor section includes a driving part configured to rotate and a movement part coupled to the driving part and configured to clean a cover glass of the sensor section by moving along the cover glass based on rotation of the driving part. The movement part is configured to contact a surface of the cover glass and to perform a reciprocating motion for cleaning the surface of the cover glass, the surface of cover glass having (i) a first area corresponding to a sensor that is disposed in the sensor section of the vehicle and (ii) a second area disposed outside the first area. The movement part is configured to move at a first speed in the first area of the cover glass and to move at a second speed in the second area of the cover glass, the second speed being different from the first speed.

Implementations according to this aspect can include one or more of the following features. For example, the first speed can be constant, and the second speed comprises an accelerated speed and a decelerated speed, where the movement part is configured to (i) move at the accelerated speed at a first portion of the second area of the cover glass, (ii) move at the first speed in the first area, and then (iii) move at the decelerated speed at a second portion of the second area of the cover glass.

In some implementations, the vehicle sensor cleaning device can further include a case defining a housing space that accommodates the driving part and the movement part therein, the housing space having an open front side. In some examples, the driving part can include a motor configured to perform a forward rotation and a reverse rotation. In some examples, the movement part can include an arm head rod coupled to the driving part, a retainer hingedly connected to the arm head rod in a vertical direction, and a blade coupled to the retainer and configured to wipe the cover glass.

In some implementations, wherein the blade can include a blade holder detachably coupled to the retainer and a wiper disposed parallel to a front surface of the blade holder. In some examples, the movement part can further include an elastic member disposed parallel to one side surface of the arm head rod and configured to pull the movement part toward the driving part. In some examples, the wiper is located at the blade holder and is configured to contact the surface of the cover glass by elasticity of the elastic member.

In some implementations, the elastic member can include a tensile spring or a compression spring configured to pull the blade toward the driving part. In some examples, the movement part has a cantilever shape fixed to the driving part.

In some implementations, the vehicle sensor cleaning device can further include a nozzle located adjacent to the cover glass and configured to spray cleaning fluid toward the cover glass. In some implementations, the vehicle sensor cleaning device can further include a cooling fan disposed at the case and configured to circulate and cool internal air of the case.

In some implementations, the arm head rod can be one of a plurality of arm head rods, where the movement part further includes an elastic member coupled to at least one of the plurality of arm head rods. In some examples, the movement part can include at least two arm head rods that are branched from a portion coupled to the driving part, and an elastic member coupled to each of the at least two arm head rods.

In some implementations, the movement part can further include retainers hingedly connected to the at least two arm head rods, respectively, and blades coupled to the retainers, respectively, and configured to wipe the cover glass.

According to another aspect, a vehicle sensor cleaning device for a vehicle having a sensor section includes a motor, an arm head rod coupled to the motor and configured to rotate based on rotation of the motor, and a wiper connected to the arm head rod and configured to contact a surface of a cover glass of the sensor section and to perform a reciprocating motion for cleaning the surface of the cover glass, the surface of cover glass having (i) a first area corresponding to a sensor that is disposed in the sensor section of the vehicle and (ii) a second area disposed outside the first area. The wiper is configured to move at a first speed in the first area of the cover glass and to move at a plurality of second speeds in the second area of the cover glass, the plurality of second speeds being different from the first speed.

Implementations according to this aspect can include one or more of the following features or the features described above. For example, the first speed is constant, and the plurality of second speeds include an accelerated speed and a decelerated speed, where the wiper is configured to (i) move at the accelerated speed at a first portion of the second area of the cover glass, (ii) move at the first speed in the first area, and then (iii) move at the decelerated speed at a second portion of the second area of the cover glass.

In some implementations, the vehicle sensor cleaning device can further include a retainer hingedly connected to the arm head rod, where the wiper is coupled to the retainer. In some examples, the vehicle sensor cleaning device can further include an elastic member disposed parallel to one side surface of the arm head rod and configured to pull the retainer toward the motor. In some implementations, the arm head rod is one of a plurality of arm head rods that are branched from a portion coupled to the motor.

It is understood that the terms “vehicle,” “vehicular,” and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure.

FIG. 1 is a diagram showing an example an overall appearance of a vehicle sensor cleaning device.

FIG. 2 is a diagram showing an example of a movement part of the vehicle sensor cleaning device.

FIG. 3 is a diagram showing an example of a side surface of the vehicle sensor cleaning device.

FIG. 4 is a diagram showing an example of a front surface of the vehicle sensor cleaning device.

FIG. 5 is a diagram specifically showing the movement part and a driving part of the vehicle sensor cleaning device that are coupled to each other.

FIG. 6 is a side view of the movement part of the vehicle sensor cleaning device.

FIG. 7 is a diagram showing an example of a movement part of a vehicle sensor cleaning device.

FIG. 8 is a diagram showing an example of a movement part of a vehicle sensor cleaning device.

FIGS. 9A to 9F are diagrams each showing an example of a vehicle sensor cleaning device.

In the figures, reference numbers refer to the same or equivalent parts of the present disclosure throughout the several figures of the drawing.

### DETAILED DESCRIPTION

Hereinafter, one or more implementations will be described in detail with reference to the accompanying drawings. In describing the embodiments with reference to the accompanying drawings, the same or corresponding components will be denoted by the same reference numerals and redundant description thereof will be omitted.

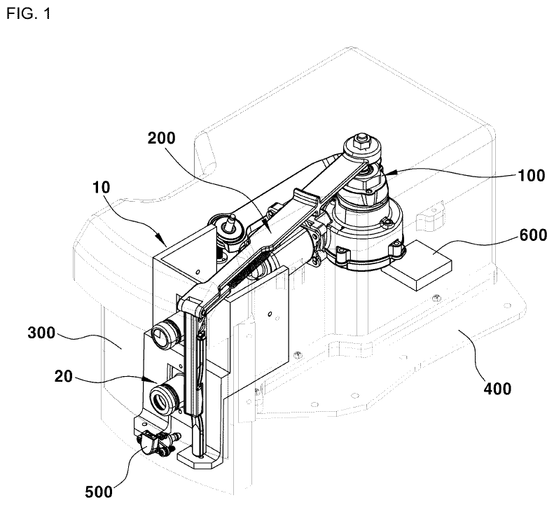

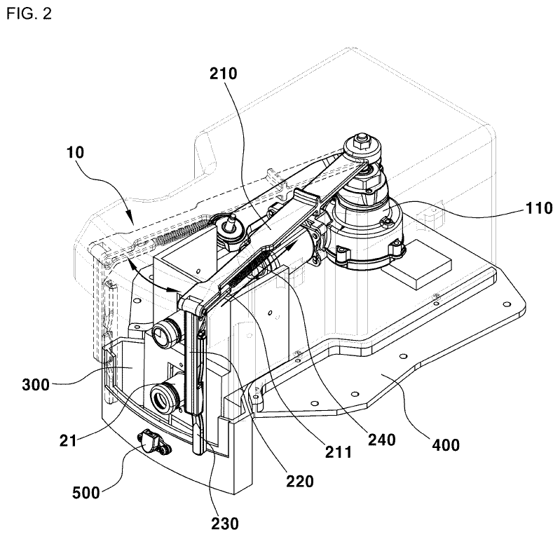

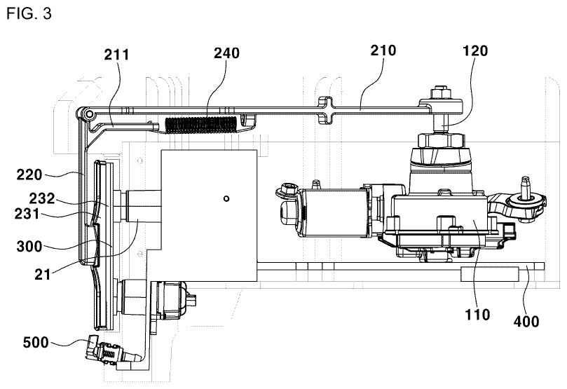

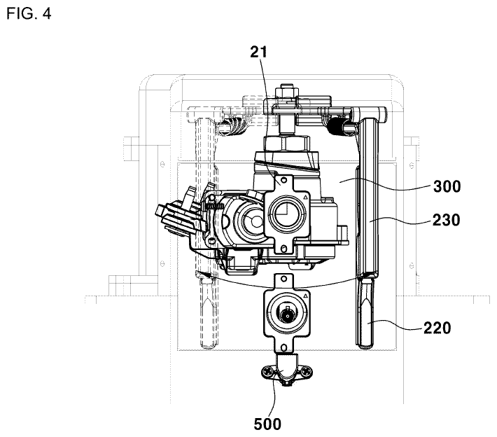

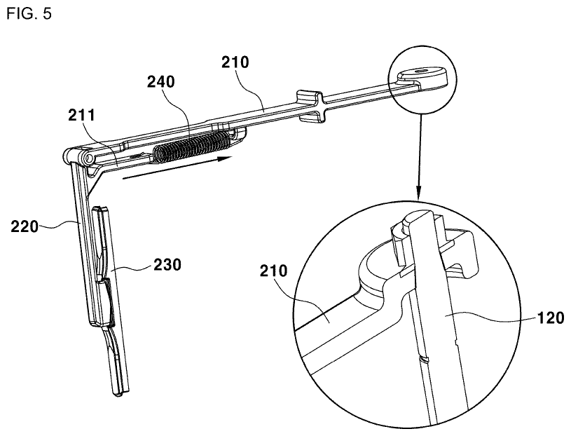

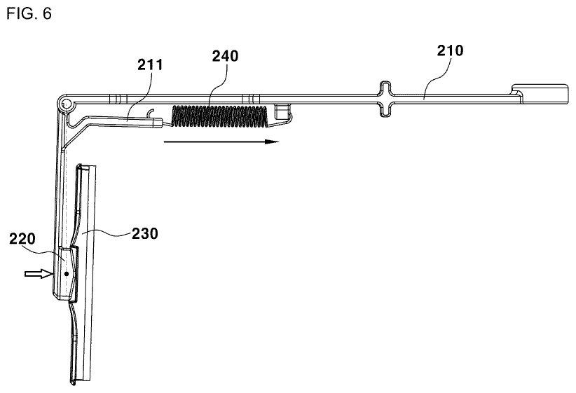

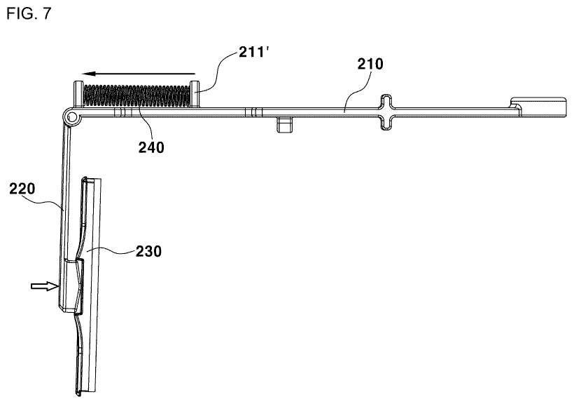

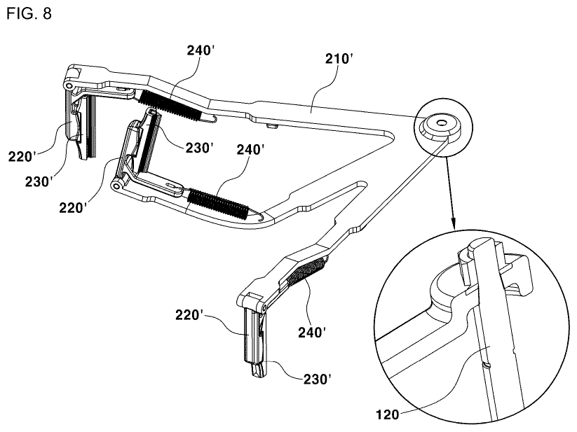

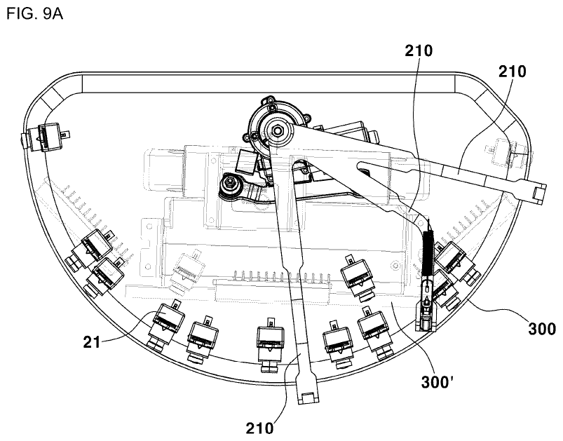

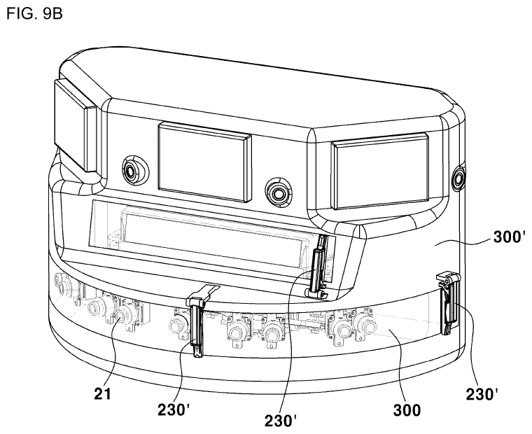

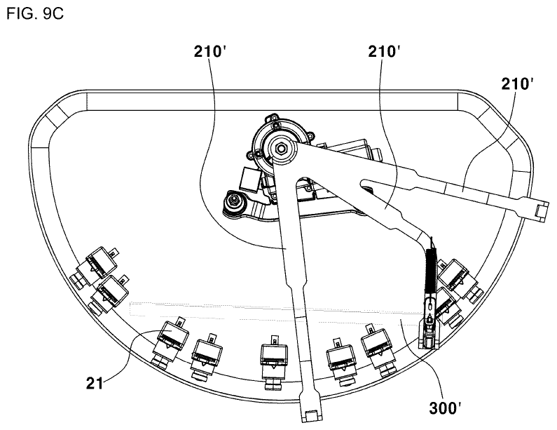

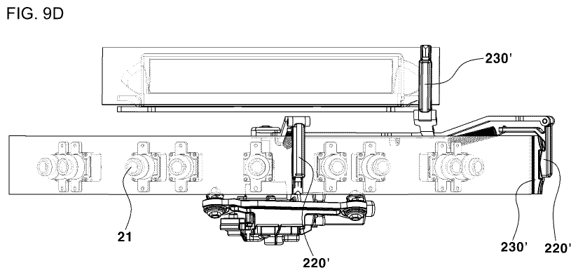

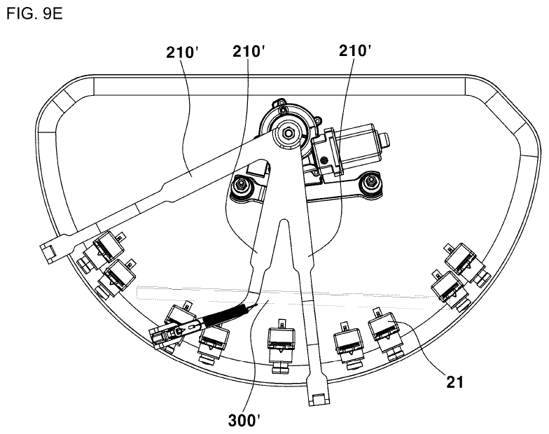

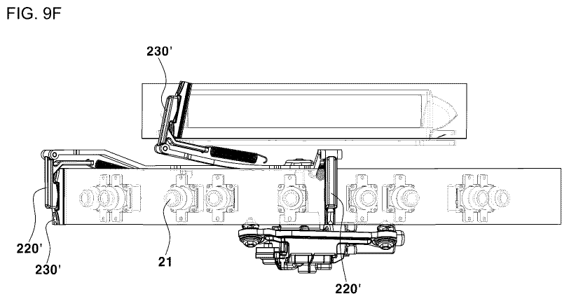

FIG. 1 is a diagram showing an example of an overall appearance of a vehicle sensor cleaning device, FIG. 2 is a diagram showing a state in which a movement part of the vehicle sensor cleaning device is driven, FIG. 3 is a diagram showing the side surface of the vehicle sensor cleaning device, FIG. 4 is a diagram showing the front surface of the vehicle sensor cleaning device, FIG. 5 is a diagram specifically showing a state in which the movement part and a driving part of the vehicle sensor cleaning device are coupled to each other, FIG. 6 is a side view of the movement part of the vehicle sensor cleaning device, FIG. 7 is a diagram showing an example of a movement part of a vehicle sensor cleaning device, FIG. 8 is a diagram showing an example of a movement part of a vehicle sensor cleaning device, and FIGS. 9A to 9F are diagrams each showing an example of a vehicle sensor cleaning device.

In some implementations, referring to FIGS. 1 to 6, a vehicle sensor cleaning device 10 can be coupled to a sensor section 20 of a vehicle and disposed in a case 400 to be described later.

In some implementations, the sensor section 20 has a sensor 21 such as a radar sensor, a camera sensor, a LiDAR sensor, or the like integrally installed therein. A plurality of sensor systems can be employed in the sensor section so as to recognize the surrounding environment of a vehicle. In addition, a camera sensor can be installed on the roof of an autonomous vehicle so as to recognize the front state of the vehicle. Further, the sensor 21 can be configured to recognize the front state of a vehicle, and any sensor capable of recognizing the front state of a vehicle can be employed.

The vehicle sensor cleaning device 10 includes a driving part 100 having a rotation output mechanism, a movement part 200 moved by driving of the driving part 100, a cover glass 300 coupled to the case 400 and configured to transparently close the front side of the sensor 21, the case 400 having the driving part 100 and the movement part 200 accommodated therein, a nozzle 500 configured to spray washer fluid (or cleaning fluid), and a cooling fan 600 configured to circulate and cool the internal air of the case 400. For example, the washing fluid can include water and detergent.

In some examples, the driving part 100 of the vehicle sensor cleaning device 10 includes a motor 110 and a motor shaft 120 and has a rotation output mechanism. The motor 110 of the driving part 100 is located in the internal space (“housing space”) of the case 400, transmits power to the motor shaft 120, regulates a predetermined rotation speed thereof, and is driven to perform forward rotation or reverse rotation thereof. Specifically, the motor 110 is driven by a controller so as to perform forward rotation or reverse rotation. Here, the motor 110 can be equipped with a programmable MCU and an encoding system capable of controlling and regulating the angle of forward rotation and reverse rotation. Further, the motor 110 can communicate with a vehicle via LIN or CAN. In addition, the motor 110 can be a brushless direct current (BLDC) motor.

In some examples, the motor shaft 120 of the driving part 100 can be connected to the motor 110. In some examples, the motor shaft is connected to a worm gear and a worm wheel capable of converting driving force of the motor 110 into rotational force. Further, the motor shaft is rotated by the worm gear and the worm wheel and serves to rotate the movement part 200 to be described later.

In some implementations, the movement part 200 of the vehicle sensor cleaning device 10 includes an arm head rod 210, a retainer 220, a blade 230, and an elastic member 240.

For example, the arm head rod 210 of the movement part 200 is formed to have a straight shape. The arm head rod 210 has one end connected to the motor shaft 120 by a fixing nut and the other end hinged to the retainer 220 to be described later. The arm head rod 210 is driven by rotation of the motor shaft 120 so as to perform forward rotation and reverse rotation thereof. Further, the position of the arm head rod 210 is regulated through a guide (not shown), and the arm head rod serves to transmit rotational force to the retainer 220. In addition, the arm head rod 210 can be configured to further include at least one horizontal member 211 located horizontally with the ceiling of a vehicle and is disposed in a direction parallel to the arm head rod 210. The horizontal member 211 can be provided for coupling of the elastic member 240 and can be disposed on the other end of the arm head rod 210 hinged to the retainer 220. Further, the horizontal member 211 is configured to support elasticity of the elastic member 240 and to press the blade 230 toward the cover glass 300. The horizontal member can be located adjacent to the retainer 220.

Specifically, referring to FIG. 5, the horizontal member 211 is equipped with the elastic member 240. Here, elasticity of the elastic member 240 is used to pull the arm head rod 210 toward the driving part 100, thereby bringing the blade 230 into close contact with the cover glass 300.

In addition, referring to FIG. 7, depending on the type of the elastic member 240 mounted on the arm head rod 210, the movement part 200 can further include a compression spring hanger 211′.

The compression spring hanger 211′ of the arm head rod 210 is located at the other end of the arm head rod 210 and is located on the upper surface of the arm head rod 210. The compression spring hanger is formed to support elasticity of the elastic member 240 by allowing the elastic member 240 to be mounted thereon. In some examples, a compression spring is coupled to the compression spring hanger 211′ such that the retainer 220 is pulled toward the cover glass 300.

The arm head rod 210 can employ either the horizontal member 211 or the compression spring hanger 211′ depending on the type of implementation. In this case, any component can be employed as long as it is possible to mount the elastic member 240 configured to pull the blade 230 toward the cover glass 300 on the component.

In some implementations, the retainer 220 of the movement part 200 is vertically hinged to the arm head rod 210 and is rotated around the hinge. Further, the retainer 220 transmits rotational force of the arm head rod 210 to the blade 230 and converts elasticity of the elastic member 240 into force pressing the blade 230. In addition, a position at which the retainer 220 and the arm head rod 210 are hinged to each other can be located on the same line as a position at which the blade 230 and the retainer 220 are hinged to each other. Depending on the type of implementation, the position at which the retainer 220 and the blade 230 are hinged to each other can be located behind the position at which the retainer 220 and the arm head rod 210 are hinged to each other by a predetermined distance on the vertical line.

Specifically, the retainer 220 of the movement part 200 performs force conversion so as to press the blade 230 toward the cover glass 300 through the elastic member 240. Here, the retainer 220 is moved along the cover glass 300 by driving of the driving part 100 while performing reciprocating motion in the leftward-and-rightward direction. In addition, the retainer 220 can clean any foreign substance attached to the cover glass by combining the pressing direction and pressing force of the elastic member 240 with the rotation direction and rotation force of a wiper 232 of the blade 230 in consideration of the length of the blade 230 and the pressing pressure of the elastic member 240.

In some implementations, the blade 230 of the movement part 200 is coupled to the retainer 220. The blade 230 is in close contact with the cover glass 300 by pressing force of the arm head rod 210 and performs a function of cleaning the cover glass 300 by driving of forward rotation and reverse rotation driving of the arm head rod 210. Here, the blade 230 includes a blade holder 231 and the wiper 232.

The blade 230 is formed of the blade holder 231 coupled to the retainer 220 and the wiper 232 that cleans the cover glass 300. The blade holder 231 of the blade 230 is stably coupled to the retainer 220, and the wiper 232 is attached to one surface of the blade holder 231 such that the wiper 232 cleans the cover glass 300 by rotation of the arm head rod 210.

The elastic member 240 of the movement part 200 can be formed of a tensile spring or a compression spring as described above. As shown in FIGS. 6 and 7, when a tensile spring is adopted, the tensile spring is mounted on the horizontal member 211, and when a compression spring is adopted, the compression spring is mounted on the compression spring hook 211′ to provide elasticity to the retainer 220, thereby performing a function of bringing the blade 230 into close contact with the cover glass 300.

The cleaning device 10 includes the cover glass 300. The cover glass 300 is configured to protect the front surface of the sensor 21 and to transparently close the open front side of the case 400. The cover glass 300 can be bonded to the case 400 by adhesion and can be formed of glass or synthetic resin. In addition, the cover glass 300 is formed to have a flat or curved shape and has a structure in which the horizontal length is longer than the vertical length.

The cleaning device 10 further includes the case 400 configured to allow the cover glass 300 to be coupled to the open front surface thereof and to accommodate the driving part 100 and the movement part 200 therein. The case 400 is formed of a lower cover that accommodates the driving part 100, the movement part 200, and the cooling fan 600, and an upper cover that protects the driving part 100, the movement part 200, and the cooling fan 600.

The cleaning device 10 further includes the nozzle 500 that sprays cleaning fluid onto the cover glass 300. The nozzle 500 can be coupled to the lower cover of the case and can be oriented at an oblique angle instead of a right angle on the lower cover. If cleaning fluid is sprayed onto the cover glass 300 at an oblique angle rather than a right angle, cleaning fluid can be optimally sprayed onto the cover glass 300. Therefore, it is possible to efficiently control the amount of cleaning fluid sprayed onto the cover glass 300.

In some implementations, the cleaning device 10 further includes the cooling fan 600. The cooling fan 600 discharges air inside the case 400 to the outside and circulates the air to cool the internal space of the case 400.

In some examples, the movement part 200 of the cleaning device 10 is formed in a cantilever shape fixed to the driving part 100. The movement part 200 has the retainer 220 coupled to the other end thereof, and the blade 230 coupled to the retainer 220 performs reciprocating motion in the left and right directions through forward rotation and reverse rotation of the retainer 220, thereby moving along the outer surface of the cover glass 300.

Specifically, the movement part 200 performs reciprocating motion while moving in the left and right directions through a guide (not shown) so as to clean the cover glass 300. In an area of the cover glass where the sensor 21 is located, the cover glass 300 moves at a constant speed (a first speed), and in an area of the cover glass 300 where the sensor 21 is not located, the cover glass 300 moves at an accelerated speed or a decelerated speed. The accelerated speed and the decelerated speed can be referred to second speeds, which are different from the first speed. For example, while controlling forward rotation, reverse rotation, the angle, and the speed of the driving part 100, the movement part 200 can move at an accelerated speed or a decelerated speed in the area of the cover glass 300 where the sensor 21 is not located and can move at a constant speed in the area of the cover glass 300 where the sensor 21 is located. For example, when the movement part 200 is driven, the movement part moves to an area of the cover glass 300 where the sensor 21 is not located. At this time, the movement part 200 moves at an accelerated speed. When the movement part moves to an area of the cover glass 300 where the sensor 21 is located, the movement part 200 moves at a constant speed. Further, when the movement part moves again to the area of the cover glass 300 where the sensor 21 is not located, the movement part 200 moves at a decelerated speed.

When the movement part 200 moves in the opposite direction, the movement part moves at the same speed as described above. That is, the movement part 200 moves along the surface of the cover glass 300 in the order of the accelerated speed, the constant speed, and the decelerated speed. In this manner, the movement part 200 can clean contaminants on the surface of the cover glass 300.

As described above, in the area of the cover glass where the sensor 21 is not located, reversal noise and the like can be maximally reduced, and the movement part 200 can move at a low speed, whereas in the area of the cover glass where the sensor 21 is located, the movement part 200 can move at the maximum speed.

FIG. 8 is a diagram showing an example of a movement part of a vehicle sensor cleaning device, and FIGS. 9A to 9F are diagrams each showing an example of a vehicle sensor cleaning device.

Referring to FIG. 8, an example of the vehicle sensor cleaning device will be described. For example, an arm head rod 210′ of the movement part 200 can be configured to branch into at least two arm head rods. As shown in FIG. 8, each of the arm head rods 210′ can be configured to be equipped with an elastic member 240′ so as to pull a blade toward a driving part. For example, in the movement part, one or more retainers 220′ can be respectively hinged to one or more arm head rods 210′, and one or more blades 230′ can be respectively coupled to one or more retainers 220′. In addition, at least one cover glass 300 is provided, and the respective angles of the arm head rods 210′ can be set differently. In this manner, the arm head rods can be used to clean cover glass 300′ located adjacent to the sensor among the cover glasses.

Specifically, referring to FIGS. 9A to 9F, for example, the angel of the retainer 220′ hinged to the centrally located arm head rod 210′ is bent at an angle different from that of the other retainers. In other words, the end of the centrally located arm head rod 210′ is bent at an obtuse angle (refer to FIGS. 9C and 9E). Here, when the retainers 220′ are rotated around the respective hinges, a structure of the retainer 220′ coupled to the arm head rod at a different angle allows the retainer 220′ located at the center to move in a straight direction and clean the cover glass 300′ (refer to FIGS. 9D and 9E). Accordingly, the cover glass 300 located adjacent to the sensor 21 can be cleaned through the retainers 220′ respectively coupled to two arm head rods 210′ respectively located on both sides of the centrally located arm head rod 210′, and the cover glass 300′ located apart from the cover glass 300 can be cleaned at the same time through the retainer 220′ coupled to the centrally located arm head rod 210′. The movement part can also move with an accelerated speed or a decelerated speed in an area of the cover glass where the sensor is not located and can also move at a constant speed in an area of the cover glass where the sensor is located.

In some implementations, a vehicle sensor cleaning device can make it possible not only to intuitively clean cover glass, but also to quickly remove contaminants that may not be removed by air and a washer cleaning system.

In addition, the cover glass is located in front of a sensor so as to effectively protect the expensive sensor.

Lastly, a cooling fan is installed inside a case so as to prevent generation of moisture inside the case and to cool the sensor, thereby effectively performing a sensor function.

As is apparent from the above description, the present disclosure can achieve the following effects by the configuration, combination, and use relationship described in the embodiments.

The present disclosure can provide a device capable of intuitively and effectively cleaning cover glass covering a sensor.

The present disclosure has been described in detail with reference to example implementations thereof, and the present disclosure can be used in various other combinations, modifications, and environments. That is, it will be appreciated by those skilled in the art that changes can be made in these embodiments without departing from the principles and spirit of the disclosure, the scope of which is defined in the appended claims and equivalents thereto. The embodiments describe the best mode to implement the technical idea of the present disclosure, and various changes in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

What is claimed is:

1. A vehicle sensor cleaning device for a vehicle having a sensor section, comprising:
a driving part configured to rotate; and
a movement part coupled to the driving part and configured to clean a cover glass of the sensor section by moving along the cover glass based on rotation of the driving part,
wherein the movement part is configured to contact a surface of the cover glass and to perform a reciprocating motion for cleaning the surface of the cover glass, the surface of cover glass having (i) a first area corresponding to a sensor that is disposed in the sensor section of the vehicle and (ii) a second area disposed outside the first area, and
wherein the movement part is configured to move at a first speed in the first area of the cover glass and to move at a second speed in the second area of the cover glass, the second speed being different from the first speed.

2. The vehicle sensor cleaning device of claim 1, wherein the first speed is constant, and the second speed comprises an accelerated speed and a decelerated speed,
wherein the movement part is configured to (i) move at the accelerated speed at a first portion of the second area of the cover glass, (ii) move at the first speed in the first area, and then (iii) move at the decelerated speed at a second portion of the second area of the cover glass.

3. The vehicle sensor cleaning device of claim 1, further comprising:
a case defining a housing space that accommodates the driving part and the movement part therein, the housing space having an open front side.

4. The vehicle sensor cleaning device of claim 1, wherein the driving part comprises a motor configured to perform a forward rotation and a reverse rotation.

5. The vehicle sensor cleaning device of claim 1, wherein the movement part comprises:
an arm head rod coupled to the driving part;
a retainer hingedly connected to the arm head rod in a vertical direction; and
a blade coupled to the retainer and configured to wipe the cover glass.

6. The vehicle sensor cleaning device of claim 5, wherein the blade comprises:
a blade holder detachably coupled to the retainer; and
a wiper disposed parallel to a front surface of the blade holder.

7. The vehicle sensor cleaning device of claim 6, wherein the movement part further comprises an elastic member disposed parallel to one side surface of the arm head rod and configured to pull the movement part toward the driving part.

8. The vehicle sensor cleaning device of claim 7, wherein the wiper is located at the blade holder and is configured to contact the surface of the cover glass by elasticity of the elastic member.

9. The vehicle sensor cleaning device of claim 7, wherein the elastic member comprises a tensile spring or a compression spring configured to pull the blade toward the driving part.

10. The vehicle sensor cleaning device of claim 1, wherein the movement part has a cantilever shape fixed to the driving part.

11. The vehicle sensor cleaning device of claim 1, further comprising a nozzle located adjacent to the cover glass and configured to spray cleaning fluid toward the cover glass.

12. The vehicle sensor cleaning device of claim 3, further comprising a cooling fan disposed at the case and configured to circulate and cool internal air of the case.

13. The vehicle sensor cleaning device of claim 5, wherein the arm head rod is one of a plurality of arm head rods, and
wherein the movement part further comprises an elastic member coupled to at least one of the plurality of arm head rods.

14. The vehicle sensor cleaning device of claim 1, wherein the movement part comprises:
at least two arm head rods that are branched from a portion coupled to the driving part; and
an elastic member coupled to each of the at least two arm head rods.

15. The vehicle sensor cleaning device of claim 14, wherein the movement part comprises:
retainers hingedly connected to the at least two arm head rods, respectively; and
blades coupled to the retainers, respectively, and configured to wipe the cover glass.

16. A vehicle sensor cleaning device for a vehicle having a sensor section, comprising:
a motor;
an arm head rod coupled to the motor and configured to rotate based on rotation of the motor; and
a wiper connected to the arm head rod and configured to contact a surface of a cover glass of the sensor section and to perform a reciprocating motion for cleaning the surface of the cover glass, the surface of cover glass having (i) a first area corresponding to a sensor that is disposed in the sensor section of the vehicle and (ii) a second area disposed outside the first area,
wherein the wiper is configured to move at a first speed in the first area of the cover glass and to move at a plurality of second speeds in the second area of the cover glass, the plurality of second speeds being different from the first speed.

17. The vehicle sensor cleaning device of claim 16, wherein the first speed is constant, and the plurality of second speeds comprise an accelerated speed and a decelerated speed,
wherein the wiper is configured to (i) move at the accelerated speed at a first portion of the second area of the cover glass, (ii) move at the first speed in the first area, and then (iii) move at the decelerated speed at a second portion of the second area of the cover glass.

18. The vehicle sensor cleaning device of claim 16, further comprising a retainer hingedly connected to the arm head rod, wherein the wiper is coupled to the retainer.

19. The vehicle sensor cleaning device of claim 18, further comprising an elastic member disposed parallel to one side surface of the arm head rod and configured to pull the retainer toward the motor.

20. The vehicle sensor cleaning device of claim 16, wherein the arm head rod is one of a plurality of arm head rods that are branched from a portion coupled to the motor.
